(19) United States
(12) Patent Application Publication
(10) Pub. No.: US 2023/0016333 A1
(43) Pub. Date: Jan. 19, 2023

(54) CONTINUOUS-VARIABLE QUANTUM TELEPORTATION USING MICROWAVE ENABLED PLASMONIC GRAPHENE WAVEGUIDE

(71) Applicant: Abu Dhabi University, Abu Dhabi (AE)

(72) Inventors: Montasir Yousof Abdallah Qasymeh, Abu Dhabi (AE); Hichem El Euch, Abu Dhabi (AE); Muhammad Asjad, Abu Dhabi (AE)

(73) Assignee: Abu Dhabi University, Abu Dhabi (AE)

(21) Appl. No.: 17/367,348

(22) Filed: Jul. 3, 2021

(51) Int. Cl. G02B 6/122; C01B 32/182

(52) U.S. Cl. CPC G02B 6/1226; C01B 32/182; C01B 2204/02

(57) ABSTRACT

A electronic method, includes receiving, by a graphene structure, a microwave signal. The electronic method further includes receiving, by the graphene structure, two optical signals. The electronic method further includes generating, by the graphene structure, an entanglement between two optical signals and the microwave signal. The electronic method includes teleporting an unknown coherent state based on the entanglement.

### BACKGROUND

Entanglement has been used in a variety of applications that include quantum teleportation, satellite quantum communication, submarine quantum communication, quantum internet, quantum error correction, and quantum cryptography. Various configurations exist that can initiate entanglement, including the use of a beam splitter, two trapped ions entanglement, and entanglement of two microwave radiations. However, there is currently no system, method, or process that allows for efficient entangled states between two different radiations at different wavelengths and permits transportation of an unknown coherent state over long distances.

### BRIEF DESCRIPTION OF DRAWINGS

FIG. 1 is a diagram of an example model graphene structural design;

FIGS. 2A and 2B are example electronically generated graphs;

FIG. 3 is an example quantum teleportation system;

FIGS. 4A and 4B are example electronically generated graphs; and

FIGS. 5 and 6 are example computing devices.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may provide for microwave and optical entanglement using a capacitor loaded with graphene plasmonic waveguide to realize continuous variable (CV) entangled states between two different radiations at different wavelengths by using a superconducting electrical capacitor which is loaded with graphene plasmonic waveguide and driven by a microwave quantum signal. In embodiments, the interaction of the microwave mode with the two optical modes may be used for the generation of stationary entanglement between the two output optical fields. In embodiments, a resulting CV-entangled state may be used to teleport an unknown coherent state over a long distance with high efficiency. In embodiments, the stationary entanglement and the quantum teleportation fidelity are robust with respect to the thermal microwave photons that are associated with the microwave degree of freedom.

Accordingly, as described in the following figures, systems, devices, and/or methods are described for generating a continuous variable two-mode squeezed entangled state between two optical fields independent of each other in a hybrid optical-microwave plasmonic graphene waveguide system. In embodiments, two-mode squeezed entangled state between the two optical fields are used to demonstrate quantum teleportation of an unknown coherent state between two spatially distant nodes. Accordingly, as described in the following figures, achieved quantum teleportation is secure due to the fact that the fidelity, F is above the threshold Fₜₕᵣ=⅔. Thus, the continuous-variable entanglement (teleportation fidelity) can be controlled and enhanced through the interaction of the microwave mode with the two optical modes. In embodiments, such pairs of entangled modes, combined with the technique of entanglement swapping, can be used as a quantum channel to teleport quantum state over large distances.

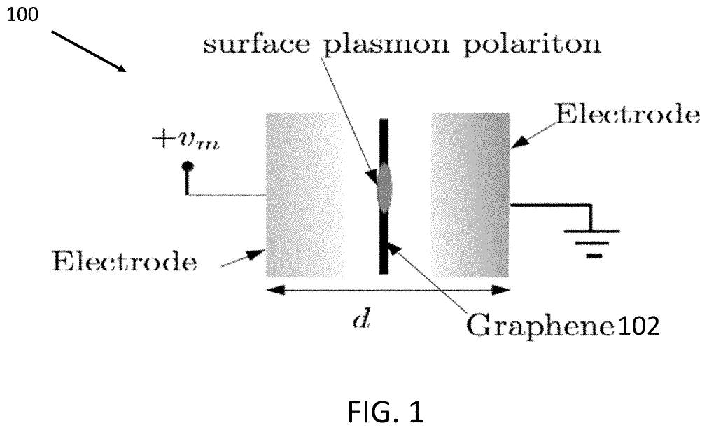

FIG. 1 shows an example graphene structure design. As shown in FIG. 1, we consider a quantum microwave signal vₘ=ve^{-iωmt}+c·c with frequency ωₘ driving a superconducting capacitor 100 of capacitance C=∈∈₀/d. In embodiments, d is the distance between the two plates of the capacitor 100. In embodiments, capacitor 100 has two plates lying in the yz-plane while a single graphene layer 102 is placed at z=0. In addition to the microwave biasing, optical fields are launched to the graphene waveguide creating surface plasmon polariton modes. In embodiments, the electrical and magnetic fields associated with a surface plasmon polariton mode of a frequency ω are given by \vec{ε}=U(z)(Dₓ(x)\vec{e}ₓ+D_{z}(x)\vec{e}^{-i(ωt-βz)}+c·c·and \vec{H}=U(z)D_{y}(x)\vec{e}_{y}e^{-i(ωt-βz)}+c·c, respectively, where U(z) is the complex amplitude, Dᵢ(x)=iKᵢ/ω∈∈₀{e^{αx} f or x<0; e^{-αx} f or x>0,} is the spatial distribution of the surface plasmon polariton mode for i=x,y,z and Kₓ=β and K_{y}=K_{z}=−iω∈∈₀. Here

$$α = \sqrt{{β}^{2} - ϵ ω / c} and β = ω / c \sqrt{1 - \frac{2}{{Z}_{0} ζ}}$$

with c is the speed of light, and Z₀ represents the free space impedance. The graphene conductivity ζ is given by equation (1) as:

$$ζ = \frac{i {q}^{2}}{4 π ℏ} ln ( \frac{2 {μ}_{c} - W}{2 {μ}_{c} + W} ) + \frac{i {q}^{2} {K}_{B} T}{π {ℏ}^{2} W} 2 ln ( {e}^{- {μ}_{c / {K}_{B} T}} + 1 )$$

where W=(ω/2π+iτ⁻¹) with τ being the scattering relaxation time, μ_{c}=h̅V_{f}\sqrt{πn₀}\sqrt{1+2Cvₘ/qπn₀} represents the chemical potential of the graphene with q is the electron charge, n₀ is the electron density, and V_{f} denotes the Dirac fermions velocity.

In embodiments, an optical pump at ω₁ is provided besides the two upper and lower side optical signals at ω₂ and ω₃, respectively. In embodiments, these optical fields are launched to the graphene layer as surface plasmon polariton modes. In embodiments, the interaction between these fields is enabled, by setting the microwave frequency equal ωₘ=ω₂−ω₁=ω₁=ω₃, and conducted through the electrical modulation of the graphene conductivity.

In embodiments, to model the interaction between the microwave and the optical fields, for weak driving microwave signal, we expand the chemical potential of the graphene u_{c}=u′_{c}+vₘu″_{c}e^{-iω}^{ₘ}^{t}+c·c to the first order in term of vₘ, where u′_{c}=h̅V_{f}\sqrt{πn₀} and u″_{c}=h̅V_{f}c/q\sqrt{πn₀}. This expansion is obtained under the assumption of Cvₘ<<qπn₀. Then, the conductivity of the graphene in equation (1) is modified and can be written as ζ_{c}=ζ′_{c}+vₘζ′_{c}e^{-iω}^{ₘ}ₜ+c·c, where ζ′_{c} has the same value as given in equation (1) and ζ″_{c}=iq²[Wμ″_{c}/πh̅[(2μ′_{c})²−W²h̅²]+K_{B}Tμ″_{c} tan h(μ_{c}/2K_{B}T)/WK_{B}T].Therefore, the effective permittivity of the graphene plasmonic waveguide is given by equation (2) as follow:

∈_{eff}=∈′+v∈|e^{-iω}^{ₘ}^{t}+c·c·

where ∈′=(cβ′/ω)², ∈″=2c²β′β″ⱼ/ω² and β′=β. Here, β″=β′ζ″_{c}(1−(Z₀ζ′/2)²)⁻^{₁}/ζ′_{c}. Consequently, a simplified description of the interaction can be obtained by substituting the effective permittivity ∈_{eff}, from equation (2), into the governing classical Hamiltonian by equation (3) as follows:

$$H = \frac{1}{2} c {v}^{2} {A}_{r} + \frac{1}{2} {\int }_{x , y , z} ( {ϵ}_{0} {ϵ}_{eff} {\vert {\vec{ε}}_{t} \vert}^{2} + {μ}_{0} {\vert {\vec{ℋ}}_{t} \vert}^{2} ) dxdydz$$

where \vec{ε}ₜ=Σⱼ₌₁³\vec{ε}ⱼ is the total electric field with \vec{ε}ⱼ=Uⱼ(z)(Dₓⱼ(x)\vec{e}ₓ+D_{zj}(x)\vec{e}_{z})e^{-i(ω}^{ⱼ}^{t-β}^{ⱼ}^{z)}+c·c (f or j=1,2,3) and [symbol] is the total magnetic field.

In embodiments, the corresponding quantized Hamiltonian that describes the three optical modes of frequencies ω₁, ω₂, ω₃, and the microwave mode, is shown in equation (4) as follows:

$$H = ℏ {ω}_{m} {\hat{b}}^{†} \hat{b} + ℏ {\sum }_{j} {ω}_{j} {\hat{a}}_{i}^{†} {\hat{a}}_{j} + ℏ {g}_{2} {\hat{a}}_{2}^{†} {\hat{a}}_{1} \hat{b} + ℏ {g}_{2} {\hat{a}}_{1}^{†} {\hat{a}}_{2} {b}^{†} + ℏ {g}_{3} {\hat{a}}_{1}^{†} {\hat{a}}_{3} {b}^{†} + ℏ {g}_{3} {\hat{a}}_{3}^{†} {\hat{a}}_{1} {b}^{†}$$

where âⱼ=U\sqrt{ξε₀ε′_{eff}V_{L}/h̅ωⱼ} is the annihilation operator of the j-th optical mode, \hat{b}=v\sqrt{CAᵣ/2h̅ωₘ} is the annihilation operator of the microwave mode,

$${V}_{L} = {A}_{r} \int ( {\vert {D}_{xj} \vert}^{2} + \vert {D}_{zj} \vert dx and {ξ}_{j} = \frac{1}{2} + \frac{{A}_{r} {u}_{0} \int {\vert {D}_{yj} \vert}^{2} dx}{2 {V}_{L {ϵ}_{0} {ϵ}_{effj}}} .$$

Here, gⱼ describes the coupling strength of the microwave mode b with the j-th optical mode, given by equation (5) as follows:

$${g}_{j} = \frac{{ϵ}_{j}^{″} {l}_{1 j}}{2 \sqrt{{ξ}_{1} {ξ}_{j}}} \sqrt{\frac{2 {ω}_{1} {ω}_{j} ℏ {ω}_{m}}{{CA}_{r} {ϵ}_{1}^{′} {ϵ}_{j}^{′}}} sin ( {θ}_{j} ) {e}^{i θ j}$$

where

$${θ}_{j} = {( - 1 )}^{j} ( {β}_{1} - {( - 1 )}^{j} {β}_{j} ) L / 2 and {l}_{mn} = \frac{\int ( {D}_{xm}^{*} {D}_{xn} + {D}_{zm}^{*} {D}_{zn} ) dx}{\sqrt{\int ( {\vert {D}_{xm} \vert}^{2} + {\vert {D}_{zm} \vert}^{2} ) dx \int ( {\vert {D}_{xn} \vert}^{2} + {\vert {D}_{zn} \vert}^{2} ) dx}} .$$

In embodiments, the surface plasmon polariton mode at frequency ω₁ is strong and therefore can be treated classically. By considering a rotating frame at frequency ωⱼ (f or j=2,3,b), and introducing the corresponding noise terms, the Heisenberg-Langevin equations of the microwave and optical operators read as equations (6a), (6b), and (6c) as follows:

\dot{\hat{b}}=γₘ\hat{b}−i [symbol] ₂â₂−i [symbol] ₃â₃^{†}+\sqrt{2γₘ}\hat{b}ᵢₙ

\dot{â}₂=−γ₂â₂−i [symbol] ₂\hat{b}+\sqrt{2γ₂}âᵢₙ_{₂}

\dot{â}₃=−γ₃â₃−i [symbol] ₃\hat{b}^{†}+\sqrt{2γ_{3,}}âᵢₙ_{₃}

where γₘ represents the damping rate of the microwave mode, and γⱼ is the decay rate of the j-th optical mode. Here [symbol] ₂=ā₁g₂ and [symbol] ₃=ā₁g₃ denote the effective coupling rates, where ā₁ being the classical amplitude. The operators âᵢₙ_{ᵢ} and \hat{b}ᵢₙ are the zero-average input noise operators for the j-th optical mode and the microwave mode, respectively, and can be characterized by [symbol] âᵢₙ_{ⱼ}^{†}(t), âᵢₙ_{ⱼ}, (t′) [symbol] =nⱼδ_{j,j}, δ(t−t′) and [symbol] \hat{b}ᵢₙ^{†}, \hat{b}ᵢₙ [symbol] =n_{b}δ(t−t′).

In embodiments, the mean thermal populations of the j-th optical mode and the microwave mode are given by nⱼ=(e^{h̅ω}^{ⱼ}^{/κ}^{_{B}}^{T}−1)⁻¹ and n_{b}=(e^{h̅ω}^{ⱼ}^{/κ}^{_{B}}^{T}−1)⁻¹ respectively, where κ_{B} is the Boltzmann constant. The optical thermal photon number can be assumed nⱼ≈0 because of h̅ωⱼ/K_{b}T>0, whereas the microwave thermal photon number nₘ is significant and cannot be conceived identical to zero even at a very low temperature. In embodiments, the two field operators â₂ and â₃ are rewritten in term of the Bogolyubov operators Â₂=â₃ cos h r+â₂^{†} sin h r and Â₃=â₂ cos h r+â₃^{†} sin h r, where cos h r= [symbol] ₂/ [symbol] , sin h r= [symbol] ₃/ [symbol] with [symbol] =\sqrt{ [symbol]₂²− [symbol] ₃²}. It then follows that the motion equations in equations (6a), (6b), and (6c) can be presented in term of the Bogolyubov modes, given by equations (7a), (7b), and (7c):

\dot{\hat{b}}=−γₘ\hat{b}−i [symbol] Â₃+\sqrt{2γₘ}\hat{b}ᵢₙ

\dot{Â}₂=−γ₂Â₂+\sqrt{2γ₂}Â_{in,2}

\dot{Â}₃=−γ₃Â₃−i [symbol] \hat{b}+\sqrt{2γ₃}Â_{in,3}

where Â_{in,2,}=a_{in,3} cos h r+â_{in,2}^{†} sin h r and Â_{in,3}=a_{in,2} cos h r+â_{in,3}^{†} sin h r. It can be inferred from the above set of equations that the considered modes of the two optical fields are entangled.

Now we consider the problem of entanglement between the outgoing light fields of the optical modes â₂ and â₃. According to the input-output theory, the output fields operators âₒᵤₜ₂ and âₒᵤₜ₃ are related to the two cavity operators â₂ and â₃ by âₒᵤₜ₂(t)=\sqrt{γ₂}â₂(t)−âᵢₙ₂(t) and âₒᵤₜ₃(t)=\sqrt{γ₃}γ₃(t)−âᵢₙ₃(t), respectively. To study the stationary entanglement between the output optical modes specified by their central frequencies ω₂ and ω₃, we define temporal filtered modes of the output fields in term of the filter functions Fₐ_{₂}(t) and Fₐ_{₃}(t), as in the following equations 8(a) and 8(b):

[symbol]

ₒᵤₜ_{₂}(t)=∫_{-∞}^{t}Fₐ_{₂}(t−τ₂)âₒᵤₜ_{₂}(t′)dτ (8a)

[symbol]

ₒᵤₜ_{₃}(t)=∫_{-∞}^{t}Fₐ_{₃}(t−τ₃)âₒᵤₜ_{₃}(t′)dτ (8b)

where [symbol] ₒᵤₜ_{₂}(t) and [symbol] ₒᵤₜ_{₃}(t) are the filtered causal bosonic annihilation operators for the output optical modes âₒᵤₜ_{₂} and âₒᵤₜ_{₃}, respectively,

$${ℱ}_{i} ( t ) = \sqrt{2 / {τ}_{i}} {e}^{- ( \frac{1}{{τ}_{i}} + i {Ω}_{i} ) t} θ ( t ) \qquad ( i = 2 , 3 )$$

is the filter function multiplied by the Heaviside step function, Ωᵢ represents the central frequency, and 1/τᵢ is the bandwidth of the i-th filter. It is convenient to rewrite equations 6(a), 6(b), and 6(c) in the following compact matrix form in equation (9) as follows:

$$\frac{d}{dt} R ( t ) = AR ( t ) + D {R}_{i n} ( t )$$

where R^{T}={â₂, â₂^{†}, â₃, â₃^{†}, \hat{b}, \hat{b}^{†}} is the column vector of the field operators, Rᵢₙ^{T}={â_{in,2}, â_{in,2}^{†}, â_{in,3}, â_{in,3}^{†}, \hat{b}ᵢₙ, \hat{b}ᵢₙ^{†}} is the column vector of the corresponding noise operators, and the superscript T indicating transposition. In embodiments, A is the drift matrix with elements that can be easily obtained from the Langevin equations set in equations 6(a), 6(b), and 6(c), D is the coefficients matrix of the corresponding input noise operators. In embodiments, for a drift matrix A with eigenvalues in the left half of the complex plane, the interaction is stable and reaching the steady state. The solution can be obtained in the frequency domain, by applying Fourier transform to equations 8(a),8(b) and (9), given by equation (10) as follows:

Rₒᵤₜ(ω)=[F(ω)M(ω)D−v(ω)] Rᵢₙ

where Rₒᵤₜ^{T}(ω)={ [symbol] ₒᵤₜ_{₂}(ω), [symbol] ₒᵤₜ_{₂}(ω), [symbol] ₒᵤₜ_{₃}(ω), [symbol] ₒᵤₜ_{₃}(ω), \hat{b}(ω), \hat{b}^{†}(ω)}, Rᵢₙ(ω) is the Fourier transform of Rᵢₙ(t), M(ω)=[A−iω]⁻¹, F(ω)=diag{\sqrt{2γ₂} [symbol] ₂(ω), \sqrt{2γ₂} [symbol] *(−ω), \sqrt{2γ₃} [symbol] ₃(ω), \sqrt{2γ₃} [symbol] ₃*(ω), 1,1} is the matrix of the filter functions, v=diag{ [symbol] ₂(ω), [symbol] *(−ω), [symbol] ₃(ω), [symbol] ₃*(−ω), 1,1}, and [symbol] ᵢ(ω) is the Fourier transform of [symbol] ᵢ(t).

Given that the operators of the quantum input noise are Gaussian, the steady-state of the system is completely described by first and second-order moments of the output field operators. In particular, it is convenient to introduce the quadratures [symbol] ₒᵤₜ_{₂}=( [symbol] ₒᵤₜ_{₂}+ [symbol] ₒᵤₜ_{₂})/\sqrt{2}, [symbol] ₒᵤₜ_{₂}=( [symbol] ₒᵤₜ_{₂}− [symbol] ₒᵤₜ_{₂})/\sqrt{2i}, \hat{X}_{Fout}_{₃}=( [symbol] ₒᵤₜ_{₃}+ [symbol] ₒᵤₜ_{₃})/\sqrt{2} [symbol] ₒᵤₜ_{₃}=( [symbol] ₒᵤₜ_{₃}− [symbol] ₒᵤₜ_{₃})\sqrt{2i}\hat{X}_{b}=(\hat{b}+\hat{b}^{†})/\sqrt{2} and Ŷ_{b}=(\hat{b}−\hat{b}^{†})/\sqrt{2i}.

In embodiments, the correlation matrix (CM)V of the system is defined as Vᵢⱼ= [symbol] uᵢuⱼ+uⱼuᵢ [symbol] /2 where u^{T}={\hat{X}_{F,out}_{₂}, [symbol] ₒᵤₜ_{₂}, \hat{X}_{F,out}_{₃}, \hat{X}_{F,out}_{₃}, \hat{X}_{b}, Ŷ_{b}} is the vector of the quadrature's for the filtered output modes. From equation (10), the stationary solution for the covariance matrix V of the filter output modes can be obtained by equation (11) as follows:

V=∫_{-∞}^{∞}QT(ω)NT(−ω)^{T}Q^{T}dw

where

$$Q = diag \{ {Q}_{2} , {Q}_{3} , {Q}_{b} \} , {Q}_{j} = \frac{1}{\sqrt{2}} ( \begin{matrix}1 & 1 \\ i & - i\end{matrix} ) , T ( ω ) = F ( ω ) M ( ω ) D - v ( ω ) and N = diag \{ {N}_{2} , {N}_{3} , {N}_{b} \}$$

is the diffusion matrix. Here,

$${N}_{b} = ( \begin{matrix}0 & {n}_{m} + 1 \\ {n}_{m} & 0\end{matrix} ) ,$$

and Nⱼ stands for 2×2 matrix of {Nⱼ}₁₂=1 (f or j=2,3) while all other elements are being zero.

In embodiments, the generation of stationary output entanglement between the two optical modes [symbol] ₒᵤₜ_{₂} and [symbol] ₒᵤₜ_{₃} is considered. In embodiments, the covariance matrix can be introduced as in the following block form, in equation (12) as follows:

$$v = ( \begin{matrix}{v}_{a 2} & {v}_{a 23} \\ {v}_{a 23}^{T} & {v}_{a 3}\end{matrix} )$$

with vₐ₂ and vₐ₃ are 2×2 covariance matrices for the two ouput optical âₒᵤₜ_{₂} and âₒᵤₜ_{₃} modes, respectively. The correlation between âₒᵤₜ_{₂} and âₒᵤₜ_{₃} can be described by the 2×2 vₐ₂₃ matrix.

The stationary entanglement between Alice's (mode âₒᵤₜ_{₂}) and Bob's (mode âₒᵤₜ_{₃}) can be measured by the negativity (i.e., quantified by the logarithmic negativity in equation (13) as follows:

E_{N}=max [0, −In2Θ⁻]

where η⁻=2^{-1/2} \sqrt{Σ²(v)=\sqrt{Σ²(v)−4det(v)}} is the smallest symplectic eigenvalue of the partially transposed 4×4 covariance matrix (CM)v with Σ(v)=det(Vₐ_{₂})+det(Vₐ_{₃})−2 det(Vₐ_{₂₃}) . A non-zero value of E_{N} quantifies the degree of entanglement between Alice's and Bob's modes.

In embodiments, having a zero-bandwidth means that 1/τⱼ→0. Therefore, the two-mode entanglement becomes independent of Ωⱼ.

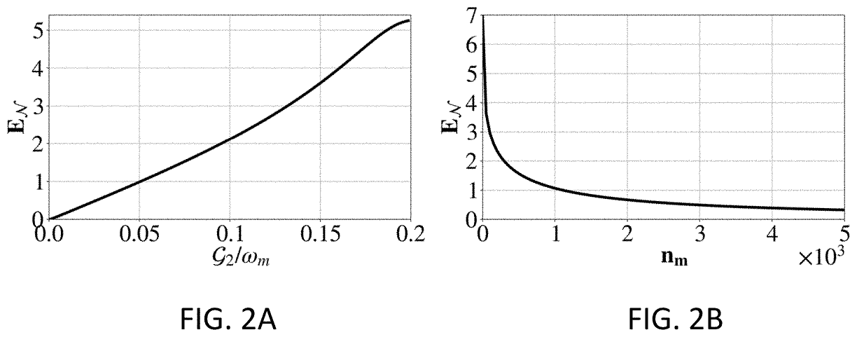

FIGS. 2A and 2B show example electronically generated graphs. As shown in FIGS. 2A and 2B, the Logarithmic negativity E_{N} is plotted to quantify the entanglement between the output modes against the effective coupling [symbol] ₂ and the microwave thermal photon nₘ. In FIG. 2A, E_{N} is plotted as a function of the parameter [symbol] ₂/ωₘ while the coupling [symbol] ₃ is fixed at [symbol] ₃=0.2ωₘ. In embodiments, the maximum value of entanglement between the two output optical modes is achieved when the two couplings fulfill the condition [symbol] ₂≈ [symbol] ₃. This can be explained by noting that the squeezing parameter r in equation (7), which is defined as the ratio of [symbol] ₃ and [symbol] ₂ couplings, is approaching one (r= [symbol] ₃/ [symbol] ₂≈1) at this condition. In FIG. 2(b), we also study the robustness of the steady state entanglement between the two optical modes â_{ont,2} and â_{out,3} as function of the microwave thermal population nₘ at the optimal condition of [symbol] ₂≈ [symbol] ₃.

In embodiments, as shown in FIG. 2B, the proposed entanglement is robust against the microwave thermal population. In embodiments, the condition [symbol] ₂≈ [symbol] ₃ can be obtained by controlling the graphene properties including the doping concentration and the layer dimensions. Thus, the two optical output modes possess Einstein-Podolsky-Rosen (EPR) correlations which is optimized for r≈1 and can be immediately exploited for quantum teleportation.

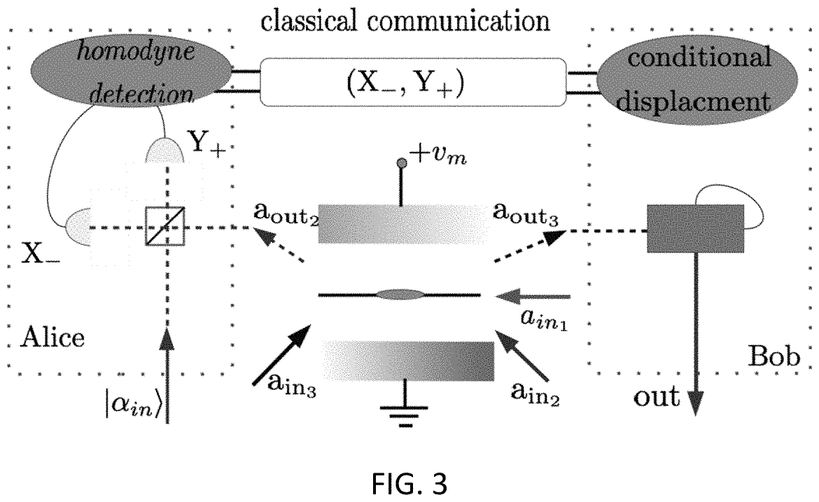

In embodiments, the EPR-like continuous variable entanglement generated between the two output fields can be characterized in term of its effectiveness as a quantum channel for quantum teleportation. In embodiments, the performance of the quantum channel can be realized in term of the teleportation fidelity of an unknown coherent state between two distant nodes labeled as Alice and Bob, as shown in FIG. 3. The two-output optical fields âₒᵤₜ_{₂} and âₒᵤₜ_{₃} possess EPR correlations and are propagating to Alice and Bob, respectively. Then, Alice combines an unknown input coherent state |αᵢₙ [symbol] to be teleported with the part of the entangled state in her hand on a beam splitter and measures the two quadrature's. 1/\sqrt{2}(\hat{X}ᵢₙ−\hat{X}_{out,2}) and 1/i\sqrt{2}(Ŷᵢₙ+Ŷₒᵤₜ_{₃},), where αᵢₙ=(\hat{X}ᵢₙ+iŶᵢₙ)/\sqrt{2}. The measurement outcomes are sent to Bob. Then Bob displaces his mode according to the measurement outcome. In embodiments, the standard two-mode teleportation between Alice and Bob, the teleportation fidelity is given by:

$$F = \frac{1}{\sqrt{det Γ}} , Γ = 2 {V}_{i n} + \overline{Z} {V}_{a 2} \overline{Z} + {V}_{a 3} - \overline{Z} {V}_{a 23} - {V}_{a 23}^{T} \overline{Z}$$

where

$$Z = diag ( 1 , - 1 ) and {V}_{in} = \frac{1}{2} diag ( 1 , 1 )$$

is the covariance matrix of the input coherent state. Moreover, the upper bound set by the entanglement on the fidelity of the CV teleportation, and optimized over the local operations, is given by equation (14) as follows:

$${F}^{opt} = \frac{1}{1 + {exp}^{- {E}_{N}}}$$

where E_{N} is the logarithmic negativity of the two-mode entanglement shared between Alice and Bob.

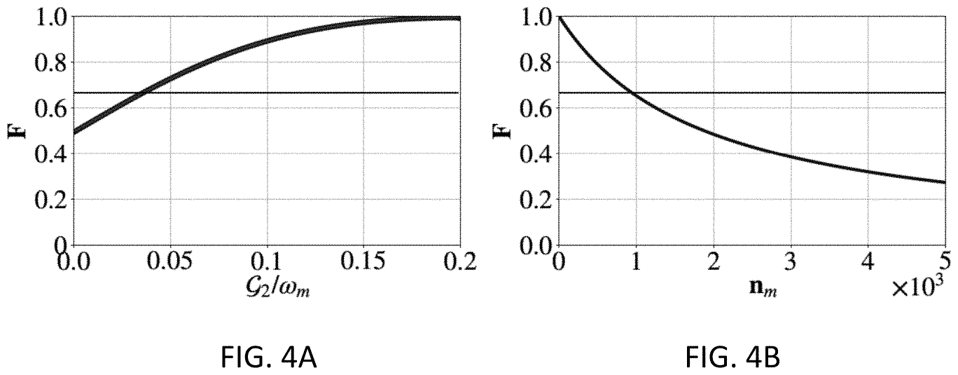

In embodiments, the corresponding quantum teleportation of an unknown optical coherent state using the obtained squeezed-state entanglement is shown in FIGS. 4A and 4B. As shown in FIG. 4A, the teleportation fidelity is plotted for a coherent state as function of the effective coupling [symbol] ₂, considering the microwave thermal population nₘ=10 and having the coupling [symbol] ₃≈0.2ωₘ. In embodiments, it can be seen from FIG. 4A that the maximum value of the fidelity (blue curve) is achieved when [symbol] ₂≈ [symbol] ₃≈0.2ωₘ. In embodiments, this is the same condition obtained for the optimal entanglement shown in FIG. 2A.

In embodiments, the maximum value of the fidelity adheres the upper bound, defined in equation (14). As shown in FIG. 4B the teleportation fidelity is analyzed for an unknown coherent state as function of the microwave thermal excitation nₘ while considering [symbol] ₃≈ [symbol] ₂≈0.2ωₘ. In embodiments, it is found that the proposed teleportation is very robust against the microwave thermal population. For example, the teleportation fidelity is above ⅔ even for nₘ=1000. This is a realization of quantum teleportation of an unknown coherent state |α> entering the device as Alice wants to teleport to Bob. In embodiments, to achieve secure quantum teleportation of coherent state, a fidelity greater than a threshold fidelity Fₜₕᵣ=⅔ is required, which is impossible to reach without the use of entanglement.

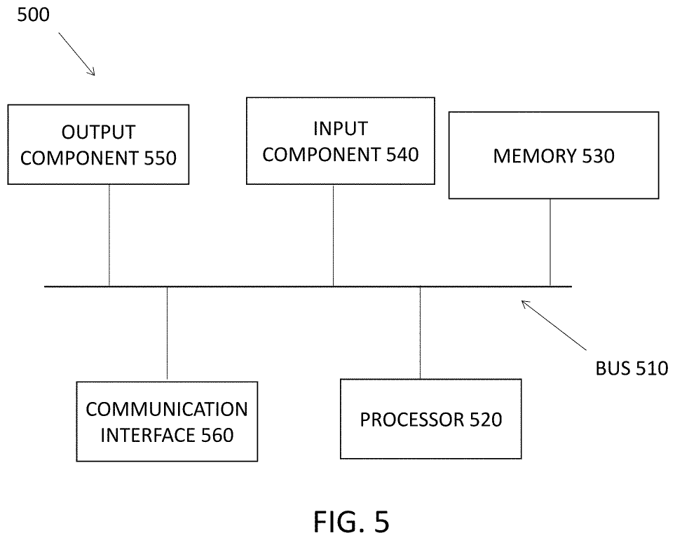

FIG. 5 is a diagram of example components of a device 500. Device 500 may correspond to a computing device, such as devices 600 and/or 610. Alternatively, or additionally, device 600 may include one or more devices 500 and/or one or more components of device 500.

As shown in FIG. 5, device 500 may include a bus 510, a processor 520, a memory 530, an input component 540, an output component 550, and a communications interface 560. In other implementations, device 500 may contain fewer components, additional components, different components, or differently arranged components than depicted in FIG. 5. Additionally, or alternatively, one or more components of device 500 may perform one or more tasks described as being performed by one or more other components of device 500.

Bus 510 may include a path that permits communications among the components of device 500. Processor 520 may include one or more processors, microprocessors, or processing logic (e.g., a field programmable gate array (FPGA) or an application specific integrated circuit (ASIC)) that interprets and executes instructions. Memory 530 may include any type of dynamic storage device that stores information and instructions, for execution by processor 520, and/or any type of non-volatile storage device that stores information for use by processor 520. Input component 540 may include a mechanism that permits a user to input information to device 500, such as a keyboard, a keypad, a button, a switch, voice command, etc. Output component 550 may include a mechanism that outputs information to the user, such as a display, a speaker, one or more light emitting diodes (LEDs), etc.

Communications interface 560 may include any transceiver-like mechanism that enables device 500 to communicate with other devices and/or systems. For example, communications interface 560 may include an Ethernet interface, an optical interface, a coaxial interface, a wireless interface, or the like.

In another implementation, communications interface 560 may include, for example, a transmitter that may convert baseband signals from processor 520 to radio frequency (RF) signals and/or a receiver that may convert RF signals to baseband signals. Alternatively, communications interface 560 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 560 may connect to an antenna assembly (not shown in FIG. 5) for transmission and/or reception of the RF signals. The antenna assembly may include one or more antennas to transmit and/or receive RF signals over the air. The antenna assembly may, for example, receive RF signals from communications interface 560 and transmit the RF signals over the air, and receive RF signals over the air and provide the RF signals to communications interface 560. In one implementation, for example, communications interface 560 may communicate with a network (e.g., a wireless network, wired network, Internet, etc.).

As will be described in detail below, device 500 may perform certain operations. Device 500 may perform these operations in response to processor 520 executing software instructions (e.g., computer program(s)) contained in a computer-readable medium, such as memory 530, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 530 from another computer-readable medium or from another device. The software instructions contained in memory 530 may cause processor 520 to perform processes described herein. Alternatively, hardwired circuitry may be used in place of or in combination with software instructions to implement processes described herein. Thus, implementations described herein are not limited to any specific combination of hardware circuitry and software.

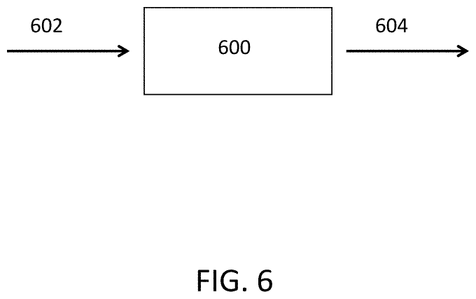

FIG. 6 is an example diagram. FIG. 6 describes device 600, communication 602, and communication 604. In embodiments, device 600 may a computing device with features/structures similar to that described in FIG. 5. In embodiments, device 600 may be a computing device that is part of a laptop, desktop, tablet, smartphone, and/or any other device that may receive communication 602, analyze communication 602, and generate output 604 based on communication 602. As shown in FIG. 6, communication 602 may be received by device 600 (e.g., via keyboard inputs, touchscreen inputs, voice inputs, etc.). In embodiments, communication 602 may include information about microwave signals, optical signals, and/or any other information.

In embodiments, device 600 may receive communication 602 and, based on one or more of equations (1) to (14), as described above, that generate output 604 that includes information about nodes, microwave signals, optical signals, and/or other information associated with equations (1) to (14).

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 11, to complete such actions. Furthermore, it will be understood that these various actions can be performed by using a touch screen on a computing device (e.g., touching an icon, swiping a bar or icon), using a keyboard, a mouse, or any other process for electronically selecting an option displayed on a display screen to electronically communicate with other computing devices. Also it will be understood that any of the various actions can result in any type of electronic information to be displayed in real-time and/or simultaneously on multiple user devices. For FIGS. 2A, 2B, 3A, and 3B, the electronic graphs may be generated by a computing device, such as device 600, and displayed via a graphical user device (GUI) associated with the computing device.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A electronic method, comprising:
receiving, by a graphene structure, a microwave signal;
receiving, by the graphene structure, two optical signals;
generating, by the graphene structure, an entanglement between two optical signals and the microwave signal; and
teleporting an unknown coherent state based on the entanglement.

2. The electronic method of claim 1, wherein the teleporting is based on a fidelity greater than ⅔.

3. The electronic method of claim 1, wherein the entanglement is a continuous variable two mode squeezed entangled state.

4. The electronic method of claim 1, wherein the graphene structure is a superconducting capacitor.
